(19) United States
(12) Patent Application Publication
(10) Pub. No.: US 2003/0217334 A1
(43) Pub. Date: Nov. 20, 2003

(54) Physical data blending system for updating live presentation documents

(76) Inventors: Peiya Liu, East Brunswick, NJ (US); Liang H. Hsu, West Windsor, NJ (US); Sudarshan Sampath, Plainsboro, NJ (US); Rajan Shah, Lawrenceville, NJ (US)

Correspondence Address: Siemens Corporation, Intellectual Property Department, 186 Wood Avenue South, Iselin, NJ, 08830, US

(21) Appl. No.: 10/151,526

(22) Filed: May 20, 2002

(51) Int. Cl. G06F 17/00

(52) U.S. Cl. 715/513; 715/500; 715/530

(57) ABSTRACT

A physical data blending system updates presentation documents live, on-the fly, during browsing whenever there is up-to-date information available on a LiveDoc Document server. LiveDoc Architecture provides for a live presentation updating system based on physical data blending methods from generating Blending Script Descriptions (BSD). LiveDoc Architecture comprises environment settings and application components including a LiveDoc-aware Browser, a LiveDoc Engine, LiveDoc Document Servers and a LiveDoc Administrator.

### BACKGROUND OF THE INVENTION

1. Field of the Invention

The present invention relates to remotely updating multimedia presentation documents and more particularly to live document updating for automatically updating presentation document content during browsing whenever there is up-to-date information available.

2. Description of the Prior Art

Traditionally, document updating has been accomplished by either reproducing whole documents with updated information or by creating leaf pages and by sending these leaf pages to customers at remote client sides. In multimedia documentation, reproduction becomes very expensive and is not a cost-effective method for small portion information updating. The leaf page updating method may be used for updating hardcopy documents, but this approach has limitations in updating electronic documents, particularly tightly-coupled content in multimedia forms. Variations of this “leaf-page” method are used to update documentation in loosely-coupled document forms such as web pages, which do not require physical data blending. In physical data blending, the up-to-date source documents need to be transformed into presentation forms for being blended into current presentation documents. With many existing multimedia documents, particularly presentation documents, the documentation content is in a tightly-coupled form with rich media and content updating requires physical data blending and document transformation. The traditional live document updating method is not adequate for tightly-coupled multimedia presentation documents. The representative live updating methods in the past can be categorized as follows:

The first is logical data blending for loosely-coupled web pages without requirement document content transformation. Examples of commercial tools based on this method are WebCD(MarkScape), LiveCD(New Alloy) and CDWeb(Banta Integrated Media). With these methods, the browsers can automatically switch document content between old hypertext HTML documents in CD at the client-side and updated HTML pages and loose-coupled media at the remote side if there is up-to-date information available. In the logical blending, up-to-date documents are used to completely replace the corresponding HTML pages without any modification at the document component level. The mechanism simply is a generalized standard web proxy capability that gets up-to-date data from web sites instead of getting web pages from the cache memory.

The second method is blending data into programs. One example of this is PiggyLand, a live game software from Online Interactive Network. This type of data blending method is used to update run-time programs with the latest data from game players. In other words, the programs behaviors are updated based on current data. This program blending method cannot be used to substitute presentation document updating due to characteristics difference between documents and programs.

### SUMMARY OF THE INVENTION

The present invention provides a new approach of content updating of remote presentation documents on-the-fly. A live presentation update process is a process to programmatically update card-based presentation documents during browsing whenever there are new or updated source documents available on servers. Users can immediately see up-to-date information in current document presentation forms at browsing time. In the prior art, the card-based document presentation update is through logical data binding for loosely-coupled presentation content. However, if documents are in tightly-coupled presentation documents like documents in ToolBook, PowerPoint, etc, the web page type of updating method is not adequate in handling such graphical-oriented presentation documents due to the requirements of physical data blending needed. The live presentation update process of the present invention includes an automated document blending transformation system for transforming new or up-to-date source SGML documents with card layout style specifications into document blending script descriptions. These script descriptions are used to generate actual updating formatting scripts at run-time for creating the update presentation document content which can be blended into tightly-coupled presentation documents on-the-fly by this physical data blending method during document browsing.

The present invention comprises LiveDoc Architecture that provides for a Live Presentation Updating System based on physical data blending methods from generating Blending Script Descriptions (BSD). LiveDoc Architecture comprises environment settings and application components including a LiveDoc-aware Browser, a LiveDoc Engine, LiveDoc Document Servers and a LiveDoc Administrator. The LiveDoc-aware Browsers are document browsers which interface with, or have built in, a LiveDoc Engine. LiveDoc Document Servers are web servers for storing up-to-date SGML documents and non-textual media. The LiveDoc Administrator is used for server administration of the LiveDoc document server and the Proxy Server. The LiveDoc Engine having built-in LiveDoc control logic for its components comprises a Thin Proxy Server (on the client site), a Document Blending Transformer, a Physical Data Blender, and an Update Source Finder.

The Document Blending Transformer takes both, the up-to-date SGML source document content and the Card Layout Style Specification (CLSS) as input, and generates blending script descriptions as output. Blending script descriptions are abstract descriptions of updating directives of presentation documents. The Physical Data Blender uses blending script descriptions to create actual blending scripts for updating card-based presentation documents on-the-fly.

The Card Layout Style Specification (CLSS) language is described in patent application Ser. No. 08/984,734, filed on Dec. 4, 1997, and entitled “Style Specifications for Systematically Creating Card-Based Hypermedia Manuals” which is hereby incorporated by reference. In the present invention, the techniques of CLSS are used for specifying the card layout of updating documents.

### BRIEF DESCRIPTION OF THE DRAWINGS

FIG. 1 illustrates the LiveDoc Architecture for the live presentation updating process which is the automatic approach of the present invention.

FIG. 2 illustrates the LiveBook button in the LiveDoc-aware Browser.

FIG. 3 illustrates the LiveDoc control logic inside the LiveDoc Engine.

FIG. 4 illustrates an example of a typical card in a presentation document before updating during browsing.

FIG. 5 illustrates an example of a typical updated card in a presentation document during browsing. The updated card title and text content are physically blended into the card-based presentation documents.

FIG. 6 illustrates the generated blending script descriptions for updating the card title with a new title (marked as revised in this case) of the card in FIG. 5.

FIG. 7 illustrates the generated blending script descriptions for replacing the card text content with the new text content on the left hand side of the text field of the card in FIG. 5.

FIG. 8 illustrates a block diagram of the Document Blending Transformer that generates updated document blending script descriptions.

FIG. 9 illustrates a block diagram of the Physical Data Blender that updates presentation documents from the blending script descriptions.

### DETAILED DESCRIPTION OF THE INVENTION

A live presentation updating process is a process based on physical data blending that programmatically updates card-based presentation documents from source documents whenever there are new or updated SGML source documents and non-textual media available during browsing. Physical data blending is a document updating operation which requires up-to-date source information that is transformed into presentable forms for being blended into presentation documents for content updating.

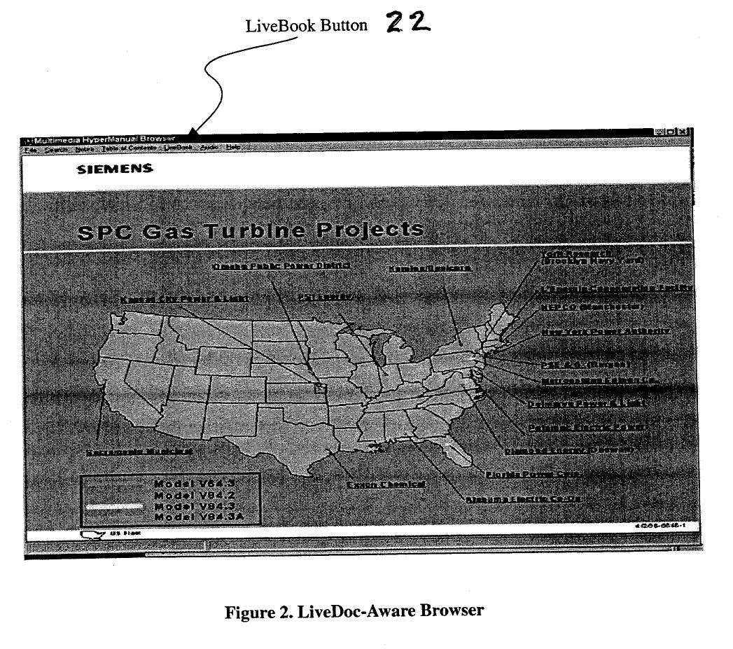

The live presentation updating process consists of three steps: new up-to-date SGML source retrieval, document blending transformation and physical data blending for updating presentation documents. On the client or local side, there are two components: LiveDoc-aware Browsers and a LiveDoc Engine. The LiveDoc-aware Browser is a presentation browser which has a built-in LiveDoc as shown in FIG. 2. In these browsers, there is a LiveBook button 22 for triggering the live presentation updating process. This process will be performed by the underlying LiveDoc Engine.

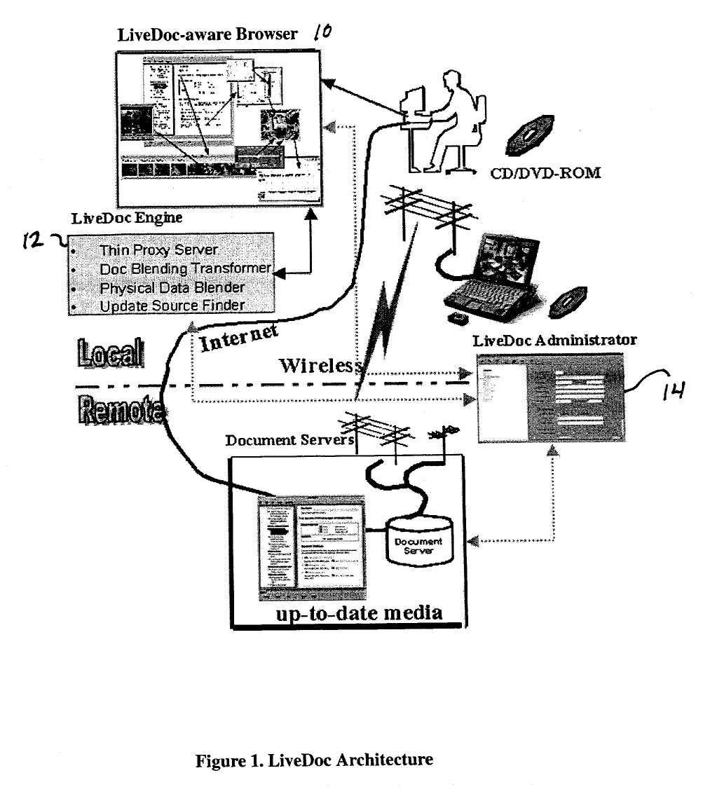

The following will describe the overall LiveDoc Architecture as shown in FIG. 1. The LiveDoc Architecture comprises LiveDoc-aware browsers 10, a LiveDoc Engine 12, a LiveDoc Administrator 14 and Document Browsers 16. The LiveDoc-aware browsers are document browsers that interface with, or have a built in, LiveDoc Engine. In this engine, there are four components: a Thin Proxy Server, a Document Blending Transformer, a Physical Data Blender and an Update Source Finder. In this architecture, the Thin Proxy Server is a background process program that obtains up-to-date information for the LiveDoc-aware browsers in the following ways. First, it can communicate with the LiveDoc Server to download up-to-date document meta information (describe where the new up-to-date documents are available in the servers) and then the Update Source Finder in the LiveDoc-aware Engine can download the documents according to the meta information. Second, it can also help the Update Source Finder to download the available up-to-date documents from the document server to the client side. Third, it can even download the update sources and can perform the document blending transformation to create the blending script descriptions on the background for the LiveDoc-aware Browsers to directly perform the physical data blending. The LiveDoc Document Server is a web server which posts new up-to-date SGML source and non-textual data. The LiveDoc Administrator manages the LiveDoc document server and the thin proxy server on the client site.

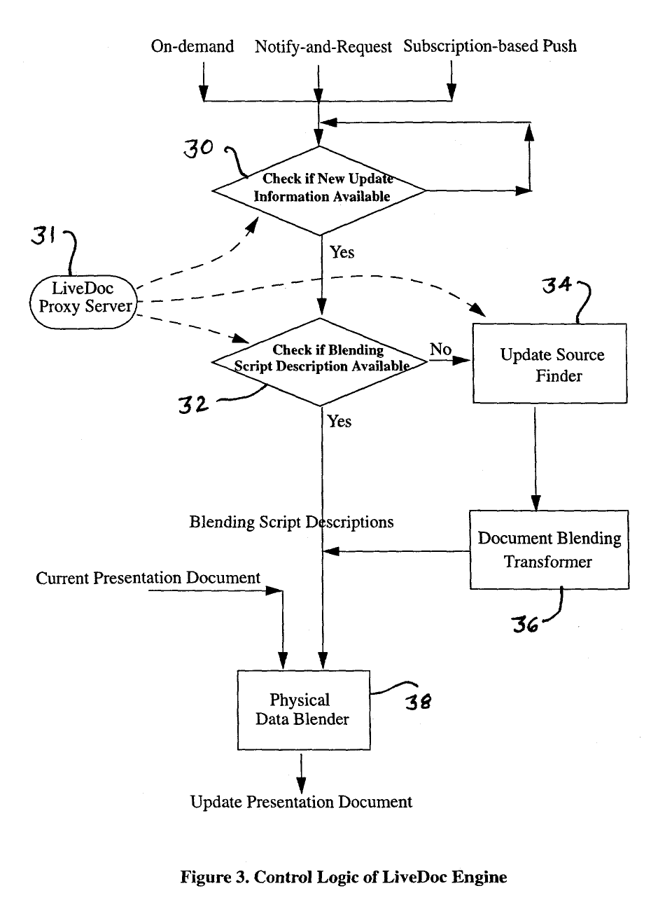

The following will describe the Control Logic in the LiveDoc Engine. The LiveDoc control logic of the LiveDoc Engine for the LiveDoc-aware browsers is shown in FIG. 3. At first, the LiveDoc-aware browsers check if there is new information available. This is shown by decision box 30. There are three ways for checking availability of new or up-to-date information: (1) on-demand from users by clicking at LiveBook Button; (2) notify-and-request by sending notes to browsers and then request via users by clicking at LiveBook button; (3) subscription-based push from document servers. If there is updated information, the LiveDoc-aware browsers will further check if there are blending script descriptions available since a thin LiveDoc proxy-server 31 at the client side could perform the document blending transformation on the background after the up-to-date source SGML and non-textual media become available. This is shown by decision box 32. If there is no blending script description available, then the Update Source Finder 34 will find up-to-date SGML sources and non-textual media either from the server 31 or from the predefined directory at the client side that is prepared for the document blending transformation. After producing the blending script descriptions, an actual presentation document update is performed, on-the-fly, during document browsing.

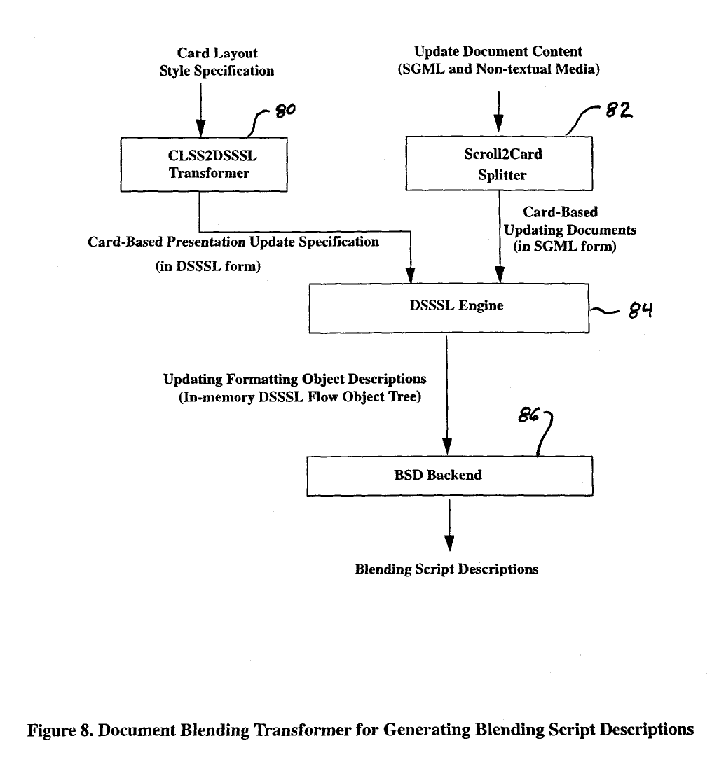

The following will describe the Document Blending Transformer, 36 of FIG. 3, within the LiveDoc Engine. Detais of the Document Blending Transformer are illustrated in FIG. 8. The Document Blending Transformer comprises four components: CLSS2DSSSL 80, Scroll2Card Splitter 82, DSSSL Engine 84, and Blending Script Description (BSD) Backend 86. CLSS2DSSSL takes the Card Layout Style Specifications as an input and transforms them into the Card-Based Presentation Update Specification(CPUS). The CLSS is used to declaratively specify the layout of the card-based presentation in a higher-level manner. The CPUS is based on ISO standard document style language, called DSSSL (Document Style Semantics and Specification Language). The CPUS is a procedural specification of an overall card-based presentation characteristic including the layout, resources and presentation procedures. The Scroll2Card Splitter divides the scroll-based up-to-date SGML source documents and the non-textual media into card-size SGML documents for preparing the blending process. The DSSSL Engine takes the Card-based Presentation Update Specifications and the card-based document content as an input and creates as an output, Update Formatting Object Descriptions(UFOD) which are DSSSL in-memory flow object trees. The UFOD is an abstract representation of the card-based document update formatting descriptions and consists of a sequence of DSSSL flow objects. Each flow object contains an up-to-date SGML data string. The BSD Backend is then used to convert the in-memory flow object tree into Blending Script Descriptions.

The following will describe Blending Script Descriptions. The Blending Script Description file consists of a sequence of descriptions about updating the documents scripts. The Document Blending Transformer, 36 of FIG. 3, creates this script description file from the updated SGML files and card layout style file, by applying the DSSSL style transformation procedure. The Physical Data Blender 38 takes the blending script description file as an input and creates an internal updated file format, on-the-fly, for all of the card-based hypermedia document objects which have property values as output. These blending script descriptions can be categorized as one of the following types: SB, CB, PB and TB.

(1) Starting Blending Script Descriptions (SB) for describing blending script description of a starting point to blend a document object. The syntax is shown as follows:

BlendingOperator=object-name

NAME=object-name

There are several blending operators: replace, delete, add, update. The replace blending operator is for replacing all properties of an object with new ones. An object represents some document content with certain properties. The update blending operator is for modifying certain properties of an object with new ones. The add blending operator is for creating new objects. The delete blending operator is used for removing existing objects. The blending operators will effect how to handle the next follow-on script descriptions in the blending script description file.

Case A: Replacing an object

REPLACE=“Field”

NAME=“TitleField”

Case B: Update a text content of a card

UPDATE=“Field”

NAME=“TextContent”

Case C: Delete a page

DELETE=“Page”

NAME=“N3000045605”

Case D: Adding a new object

ADD=“Page”

NAME=“N30004561”

(2) Property Blending Script Descriptions (PB) for describing blending scripts for setting object property values. The syntax is shown as follows:

Property-name=Property-value

Example: A formatting script description for setting value of the property “bounds” for a particular document object

bounds=“20, 20, 40, 40”

(3) Commend Blending Script Descriptions (CB) for describing blending scripts for particular script commands. The syntax is shown as follows:

COMMAND=script

Example: A blending script description for moving a object position

COMMAND=“Move button AIU by 40, 40”

Example: A blending script description for importing a document resource file

COMMAND=“Import bitmap resource

‘c:resourcebutton.bmp’ as ‘NEXT’”

(4) Terminating Blending Script Descriptions (TB) for describing blending scripts for finalization of documents at the end of a blending script description file. The syntax is shown as follows:

DONE=presentation-book-name

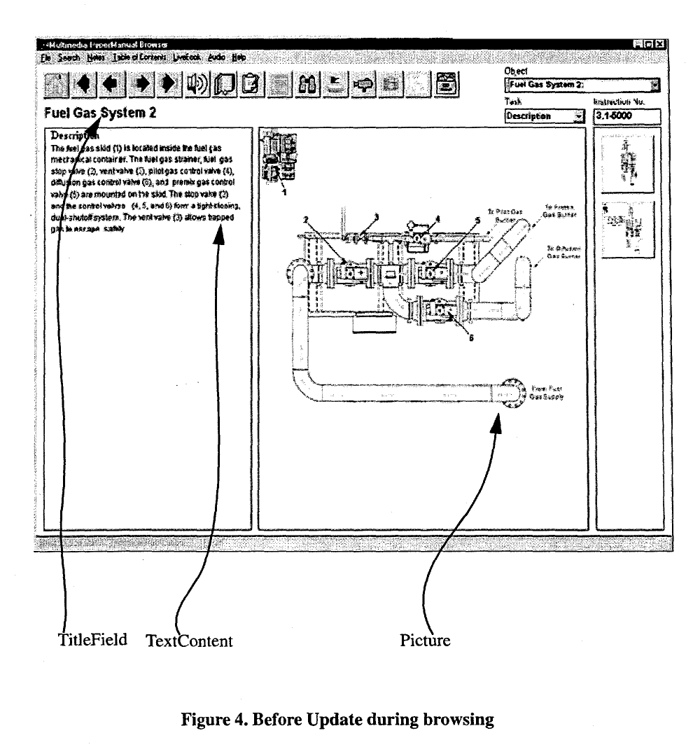

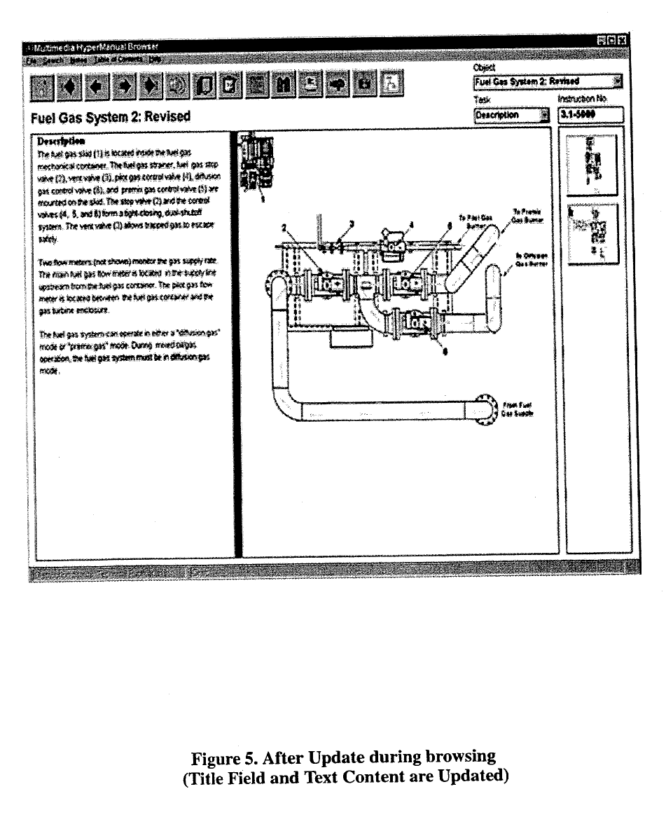

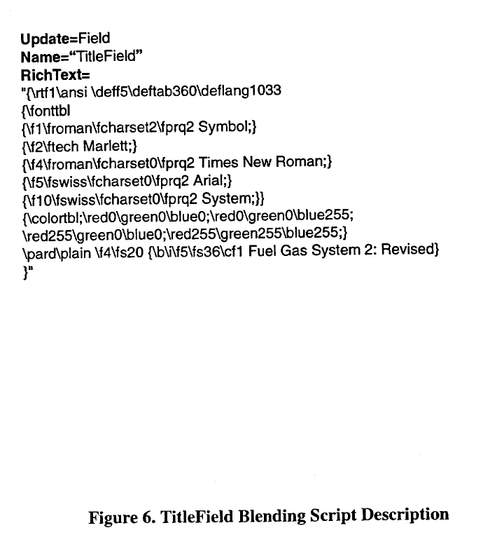

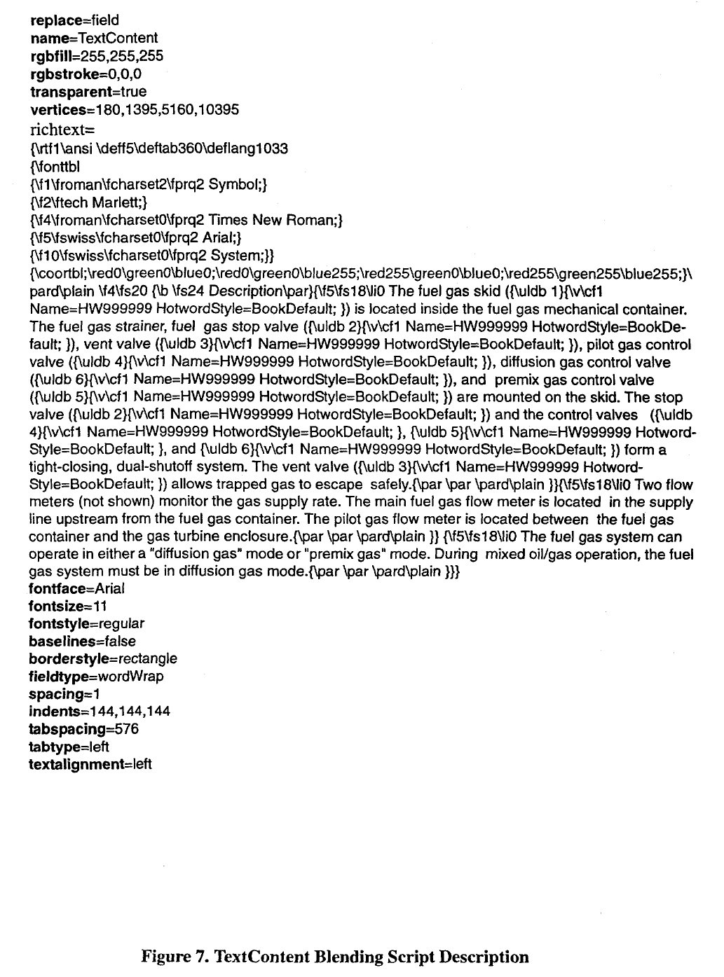

Examples of blending script descriptions for updating the TitleField object and replacing the TextContent of a card are shown in FIG. 6 and FIG. 7. These generated blending script descriptions are used to update a typical card presentation document shown in FIG. 4 and FIG. 5.

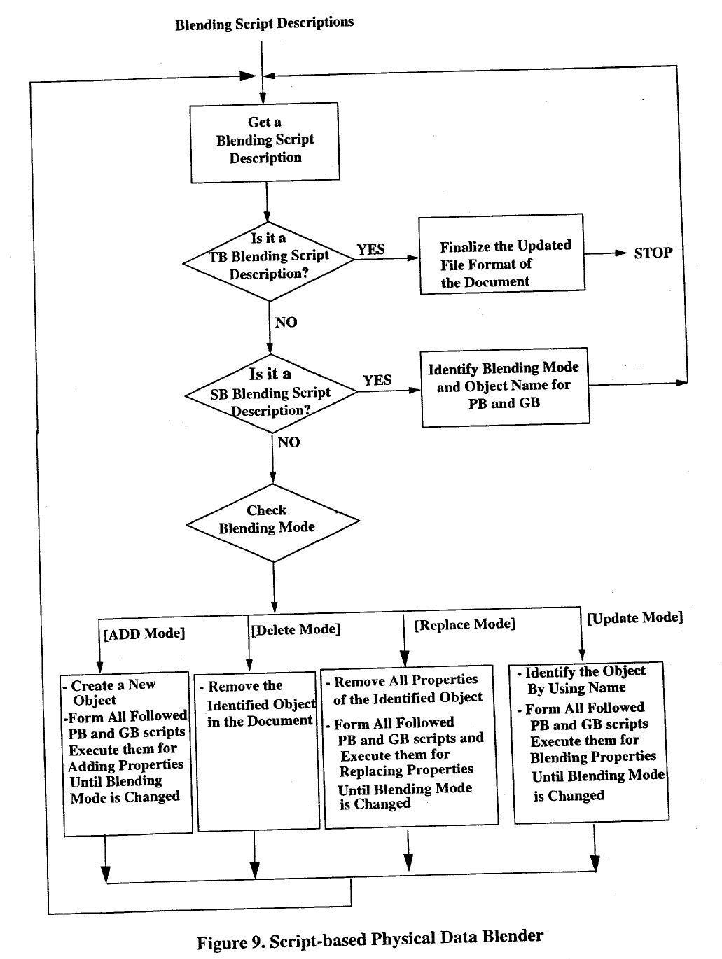

The following will describe Physical Data Blending. The script-based Physical Data Blender shown in FIG. 9 takes as an input, the blending script descriptions, and generates the actual blending scripts on-the-fly for updating the content of the presentation documents in the LiveDoc-aware browsers. The Physical Data Blender is designed as a simple and fast parsing system to dynamically form tool-specific scripts from blending script descriptions. The blending script descriptions indicate how to form real executable scripts. The final scripts will be executed by authoring tools for updating an internal format representation of card-based hypermedia documents.

In general, the execution order of dynamically formed executable blending scripts follows the sequence of blending script descriptions. There are four different kinds of blending operators, namely add, delete, replace and update. The add blending operator is used to form new objects with necessary properties, which are created by its following PB and CB script descriptions. The add new object in presentations document is due to revised SGML source maybe longer than original source and need new objects needed for adding to presentation documenst. The delete blending operator is used to remove certain content from presentation documents. The replace blending operator is used to remove all old properties of an identified object by using new properties for replacing content in presentation documents. The update operator is used to update those object properties which has new property values by next follow-on PB and CB script descriptions in the blending script description file.

1. A physical data blending system for updating live presentation documents comprising:
a LiveDoc-aware browser;
a LiveDoc engine;
a LiveDoc document server; and,
a LiveDoc administrator.

2. A physical data blending system for updating live presentation documents as claimed in claim 1 wherein said LiveDoc-aware browser comprises:
presentation document browsers able to perform a live presentation updating process.

3. A physical data blending system for updating live presentation documents as claimed in claim 1 wherein said LiveDoc engine comprises:
a thin Proxy Server;
an Update Source Finder;
a Document Blending Transformer; and
a Physical Data Blender.
